(19) United States
(12) Patent Application Publication
(10) Pub. No.: US 2005/0161284 A1
(43) Pub. Date: Jul. 28, 2005

(54) Safety device

(76) Inventors: Scott C. Casebolt, St. Paul Park, MN (US); Wayne L. Olson, Central Point, OR (US)

Correspondence Address: IPLM Group, P.A., Post Office Box 18455, Minneapolis, MN, 55418, US

(21) Appl. No.: 10/764,492

(22) Filed: Jan. 27, 2004

(51) Int. Cl. A62B 37/00

(52) U.S. Cl. 182/3

(57) ABSTRACT

A preferred embodiment safety device for use with an upright structure includes an elongate member, a connecting member, a securing member, and a lifeline. The connecting member is operatively connected to the elongate member proximate a first end of the elongate member. The connecting member extends outward from the elongate member and is configured and arranged to engage the upright structure. The securing member is operatively connected to the elongate member proximate a second end of the elongate member. The securing member is configured and arranged to extend around a portion of an anchor member. The connecting member and the securing member anchor the elongate member thereby providing an anchorage point. The lifeline is operatively connected to the elongate member, wherein the lifeline provides fall protection proximate the upright structure when the elongate member is anchored.

### BACKGROUND OF THE INVENTION

1. Field of the Invention

The present invention relates to a safety device for use with an upright structure such as a concrete column form.

2. Description of the Prior Art

There are many instances in which column forms are used to create concrete columns. During construction of parking ramps, for example, a concrete floor is first established, and the floor includes steel rebars extending generally vertically from the floor. The rebars are used to reinforce concrete columns also extending generally vertically from the floor. To create the concrete columns, column forms are placed around the rebars and then concrete is poured into the forms to create the columns.

Typically people climb on the forms themselves or use ladders when the concrete columns are being created, and people attach lifelines to the rebars proximate the top of the forms to reduce the risk of injury when performing tasks proximate the top of the forms. However, a typical form does not have sufficient structure on which to support a person, and this creates a risk of injury should someone slip on the form or should the ladder slip before the person is able to connect a lifeline to a rebar protruding out the top of the concrete column form. Therefore, it is desirable to have a safety device that reduces the risk of injury as the person is climbing up and down the safety device to perform tasks proximate the top of the form.

### SUMMARY OF THE INVENTION

A preferred embodiment safety device for use with an upright structure and an anchor member includes an elongate member, a connecting member, a securing member, and a lifeline. The elongate member has a first end, a second end, and an intermediate portion. The connecting member is operatively connected to the elongate member proximate the first end, and the connecting member extends outward from the elongate member and is configured and arranged to engage the upright structure. The securing member is operatively connected to the elongate member proximate the second end, and the securing member is configured and arranged to extend around a portion of the anchor member. The connecting member and the securing member anchor the elongate member thereby providing an anchorage point. The lifeline is operatively connected to the elongate member, wherein the lifeline provides fall protection proximate the upright structure when the elongate member is anchored.

A preferred embodiment safety device for use with a concrete column form includes an elongate member, a connecting member, a securing member, and a lifeline. The concrete column form includes a top and a base, the top having an opening providing access into a cavity. The elongate member has a first end, a second end, and an intermediate portion. The connecting member is operatively connected to the elongate member proximate the first end, and the connecting member extends outward from the elongate member. The connecting member is configured and arranged to be positioned through the opening and into the cavity of the concrete column form thereby engaging the top of the concrete column form. The securing member is operatively connected to the elongate member proximate the second end, and the securing member is configured and arranged to extend around a portion of the base of the concrete column form. The connecting member and the securing member anchor the elongate member to the concrete column form thereby providing an anchorage point. The lifeline is operatively connected to the elongate member, wherein the lifeline provides fall protection for a user proximate the concrete column form when the elongate member is anchored to the concrete column form.

A preferred embodiment safety device for use with an upright structure including a top and an anchor member includes a post, a hook, a strap, and a lifeline. The post has a first end, a second end, and an intermediate portion. The hook is operatively connected to the post proximate the first end. The hook extends outward from the post and is configured and arranged to engage the top of the upright structure. The strap is operatively connected to the post proximate the second end, and the strap is configured and arranged to extend around a portion of the anchor member. The hook and the strap anchor the post thereby providing an anchorage point. The lifeline is operatively connected to the post, wherein the lifeline provides fall protection proximate the upright structure when the post is anchored.

In a preferred embodiment method of securing a safety device including a lifeline to a concrete column form, the concrete column form includes a top and a base. The top has an opening providing access into a cavity, and the safety device is secured from a level below the top of the concrete column form. A connecting member is placed through the opening into the cavity of the concrete column form. The connecting member is operatively connected to a first end of an elongate member, and the connecting member connects the first end of the elongate member to the top of the concrete column form. A strap operatively connected to the elongate member proximate a second end of the elongate member is secured around a portion of the base of the concrete column form.

In a preferred embodiment method of securing a safety device including a lifeline to an upright structure, the upright structure includes a top. The safety device is secured from a level below the top of the upright structure. From the level below the top of the upright structure, a connecting member is placed over the top of the upright structure thereby engaging the top of the upright structure with the connecting member. The connecting member is operatively connected to a first end of an elongate member, and the connecting member connects the first end of the elongate member to the top of the upright structure. A strap operatively connected to the elongate member proximate a second end of the elongate member is secured around a portion of an anchor member. The strap is tightened around the portion of the anchor member with a ratcheting device.

### BRIEF DESCRIPTION OF THE DRAWINGS

FIG. 1 is a side view of a safety device operatively connected to a concrete column form constructed according to the principles of the present invention;

FIG. 2 is a side view of another embodiment safety device constructed according to the principles of the present invention;

FIG. 3 is a side view of a first elongate member and a second elongate member of the safety device shown in FIG. 2;

FIG. 4 is a front view of a form engaging member of the safety device shown in FIG. 2;

FIG. 5 is a front view of a support member of the safety device shown in FIG. 2;

FIG. 6 is a front view of another embodiment safety device constructed according to the principles of the present invention;

FIG. 7 is a left side view of the safety device shown in FIG. 6;

FIG. 8 is a rear view of the safety device shown in FIG. 6; and

FIG. 9 is a right side view of the safety device shown in FIG. 6.

### DETAILED DESCRIPTION OF A PREFERRED EMBODIMENT

A preferred embodiment safety device constructed according to the principles of the present invention is designated by the numerals 100, 300, and 400 in the drawings.

Although the present invention is discussed with regard to use with a concrete column form, it is recognized that the present invention may be used with other similar upright structures well known in the art such as a wall structure.

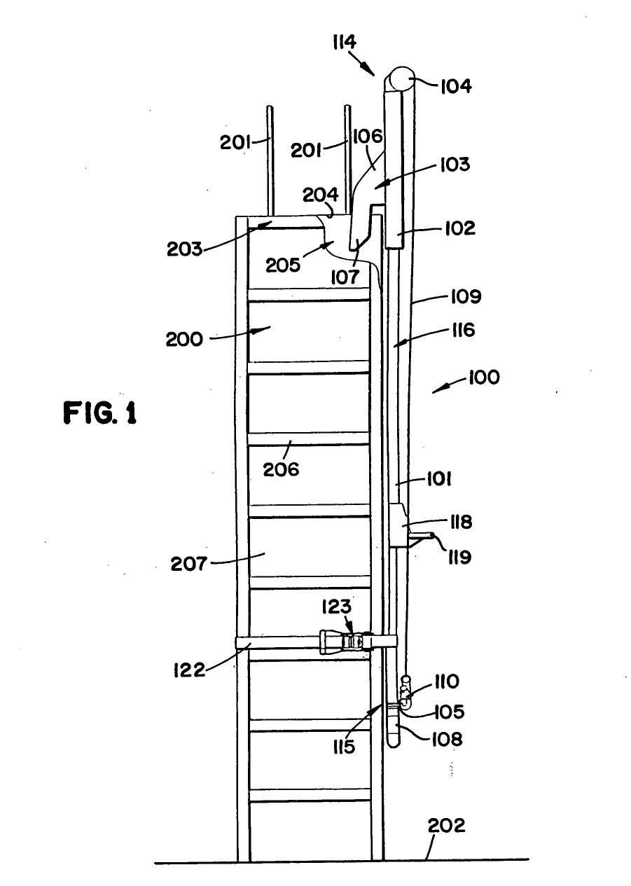

As shown in FIG. 1, the preferred embodiment safety device 100 includes an elongate member 101, a connecting member 103, a lifeline 108, a support member 119, and a securing member 122. The elongate member 101 is preferably an elongate tubular member such as a tubular post made of a sturdy material such as steel having a first end 114 proximate the top, a second end 115 proximate the bottom, and an intermediate portion 116 proximate the middle.

The connecting member 103 is operatively connected to the first end 114 of the elongate member 101 with a connector 102. The connector 102 is preferably tubular and configured and arranged to fit on the first end 114 of the elongate member 101. Preferably, the connecting member 103 extends outward and downward from the connector 102 like a hook. The connecting member 103 includes a base portion 106, which extends outward from the connector 102, and a hook portion 107, which extends downward from the base portion 106. A sheave 104 is also operatively connected to the first end 114 of the elongate member 101 proximate the top of the connector 102.

A lifeline device 108 is operatively connected to the second end 115 of the elongate member 101, but it is recognized that the lifeline 108 may be operatively connected at any location along the length of the elongate member 101. The lifeline device 108 includes a cable 109, and preferably the lifeline device 108 includes a retractable cable 109. The cable 109 is thread from the bottom to the top through the hollow center of the tubular elongate member 101 and over the sheave 104. The sheave 104 acts as a pulley to reduce the wear on the cable 109. A hook 110 is operatively connected to the end of the cable 109, and the hook 110 may be attached to a keeper 105 when not in use.

A support member 119 may be operatively connected to the intermediate portion 116 of the elongate member 101 with a connector 118. The support member 119 is adjustable along the length of the elongate member 101 and may be foldable or collapsible for ease of storage. The support member 119 provides a footrest upon which a user may stand.

A securing member 122, which is preferably a strap made of webbing, is operatively connected to the elongate member 101 proximate the second end 115. A ratcheting device 123 may be operatively connected to the securing member 122 to assist in tightening the securing member 122.

A floor 202 includes rebars 201, and a concrete column form 200 is used to form a concrete column on the floor 202 around the rebars 201. The floor 202 is at a level lower than the top 203 of the form 200. The form 200 is a hollow cylindrical member, and the top 203 of the form 200 includes an opening 204 into a cavity 205. The outside surface of the base 207 of the form 200 may include rungs 206, which may be used by a user to climb on the form 200.

In use, a user stands on the floor 202 proximate the form 200 and connects the safety device 100 to the form 200 thereby anchoring the lifeline 108 without having to climb the form 200. The floor 202 is at a level below the top 203 of the form 200. The connecting member 103 is configured and arranged to engage the top 203 of the form 200, and the user hooks the connecting member 103 onto the top 203 of the form 200. The base portion 106 of the connecting member 103 extends outward from the connector 102 over the top of the form 200, and the hook portion 107 extends downward from the base portion 106 through the opening 204 into the cavity 205 of the form 200. Then, the user secures the securing member 122 around a portion of the form 200 thereby securing the elongate member 101 to the form 200 with the securing member 122. The portion of the form 200 is an anchor member. The securing member 122 may be tightened with a ratcheting device 123. The connecting member 103 and the securing member 122 anchor the elongate member 101 to the form 200 thereby providing an anchorage point for the lifeline 108. The lifeline 108, which is preferably a self-retracting lifeline, provides fall protection for a user performing tasks proximate the form 200 when the elongate member 101 is anchored to the form 200.

Although the safety device 100 is shown being used with a concrete column form 200 in FIG. 1, it is recognized that the safety device 100 may also be used with any suitable upright structure known in the art such as but not limited to a wall. The connecting member 103 would engage the top of the upright structure and the securing member 122 would be placed about a portion of an anchor member such as but not limited to a step bolt and a post proximate the upright structure.

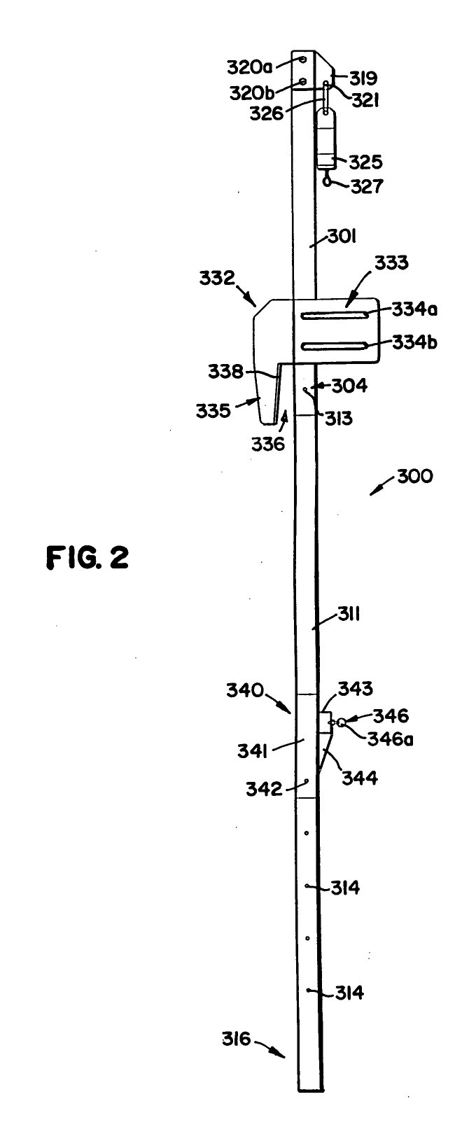

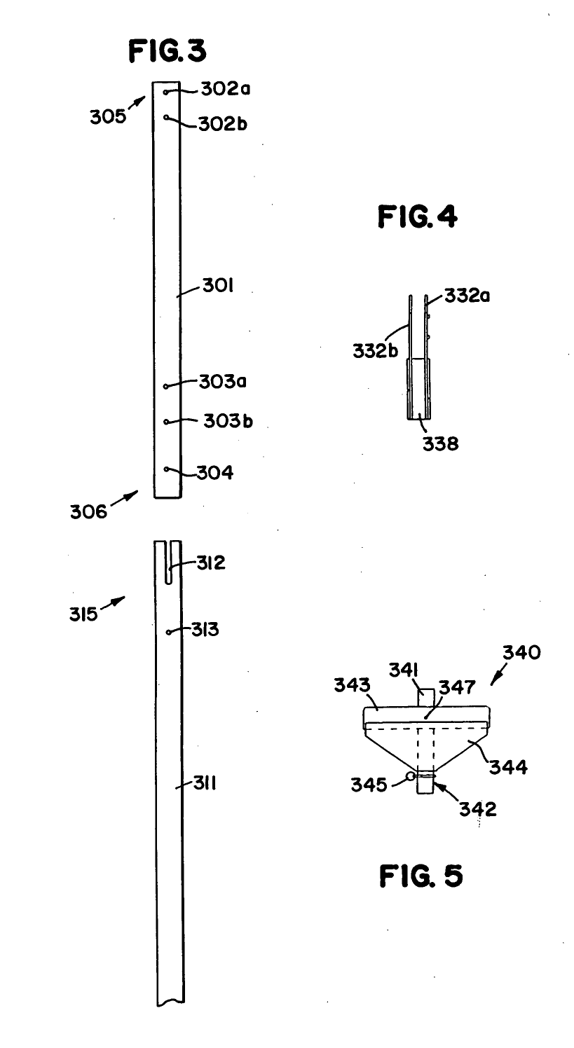

The preferred embodiment safety device 300, shown in FIGS. 2-5, includes a first elongate member 301, a second elongate member 311, a lifeline 325, a connecting member 332, and a support member 340. The first elongate member 301 has a first end 305 and a second end 306. The first end 305 includes bores 302a and 302b in vertical alignment proximate the top of the first end 305. The second end 306 includes bores 303a and 303b positioned above bore 304 in vertical alignment proximate the bottom of the second end 306. The second elongate member 311 has a first end 315 and a second end 316. The first end 315 includes a slot 312 extending to the end of the top and a bore 313 below the slot 312. The second end 316 includes a plurality of bores 314 in vertical alignment proximate the middle and the bottom of the second end 316.

The first elongate member 301 and the second elongate member 311 are preferably hollow tubular members, and the second elongate member 311 is slightly smaller in diameter to fit within the first elongate member 301. The bore 313 of the second elongate member 311 aligns with the bore 304 of the first elongate member 301, and a fastener may be inserted therethrough to secure the members 301 and 311 together. The slot 312 is configured and arranged to accommodate fasteners placed through bores 303a and 303b.

A bracket 319 includes apertures 320a and 320b, and is configured and arranged to interconnect the first elongate member 301 and the lifeline 325. The apertures 320a and 320b are configured and arranged to align with bores 302a and 302b, respectively, and fasteners are inserted therethrough to operatively connect the bracket 319 to the first elongate member 301. The bracket 319 extends outward from the first elongate member 301 on the front side of the device 300. The portion of the bracket 319 that extends outward includes an aperture 321 through which a connector 326 such as a carabiner is inserted to interconnect the bracket 319 to the lifeline 325, which is preferably a self-retracting lifeline. The lifeline 325 includes a hook 327 to which a user connects to a safety harness.

A connecting member 332 includes a first plate 332a and a second plate 332b, which are each preferably L-shaped with a bracket portion 333 and a hook portion 335, the bracket portion 333 extending outward from the first elongate member 301 and the hook portion 335 extending downward from the bracket portion 333. The first plate 332a and the second plate 332b are spaced apart to accommodate the diameter of the first elongate member 301 and are interconnected with a connecting portion 338. The bracket portions 333 each include a first slot 334a and a second slot 334b, which are configured and arranged to align with the bores 303a and 303b. Fasteners (not shown) are inserted through the slots and the bores to secure the connecting member 332 to the first elongate member 301, and the slots allow the connecting member 332 to be horizontally adjusted along the length of the slots. The hook portions 335 extend outward from the first elongate member 301 on the rear side of the device and form an opening 336 between the hook portions 335 and the first elongate member 301. Preferably, the connecting portion 338 is operatively connected to the hook portions 335 proximate the opening 336 to also act as a guide when hooking the connecting member 332 to a structure. The connecting portion 338 provides an even surface to prevent hooking just one of the hook portions 335 on the structure.

A support member 340 includes a third elongate member 341 and a ledge 343. The third elongate member 341 is preferably a hollow tubular member, and the third elongate member 341 is larger in diameter to fit over the second elongate member 311 and slide vertically thereon. The third elongate member 341 includes a bore 342 through which a fastener 345 is inserted to secure the support member 340 to the second elongate member 311, through one of the bores 314 of the second elongate member 311. In other words, the support member 340 is adjustable along the length of the second elongate member 311. The ledge 343 is operatively connected to and extends outward from the third elongate member 341 and is reinforced on its outer edge with a ledge support 344. The ledge support 344 interconnects the outer edge of the ledge 343 to the third elongate member 341, as shown in FIG. 2. The ledge 343 provides a surface upon which a user may stand to support the user while performing tasks proximate the structure. The ledge 343 optionally includes an aperture 347 through which a fastener 346 may be inserted. The fastener 346 includes an aperture 346a through which a bar member (not shown) may be inserted to provide an additional surface upon which a user may stand to support the user while performing tasks proximate the structure. A securing member (not shown) such as a strap should be used with this embodiment to secure a bottom portion of the device 300 when the connecting member 332 is hooked onto the structure.

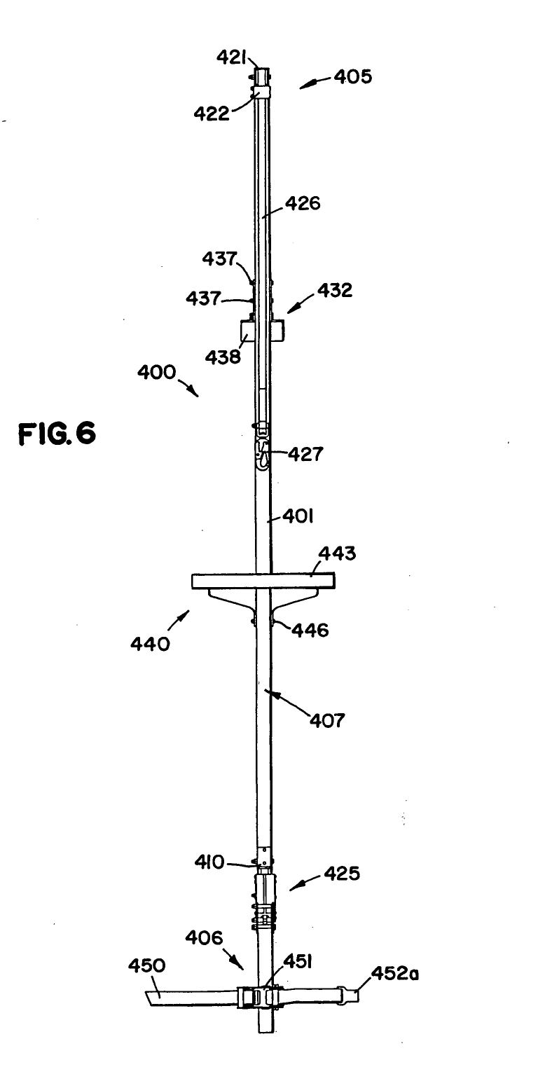

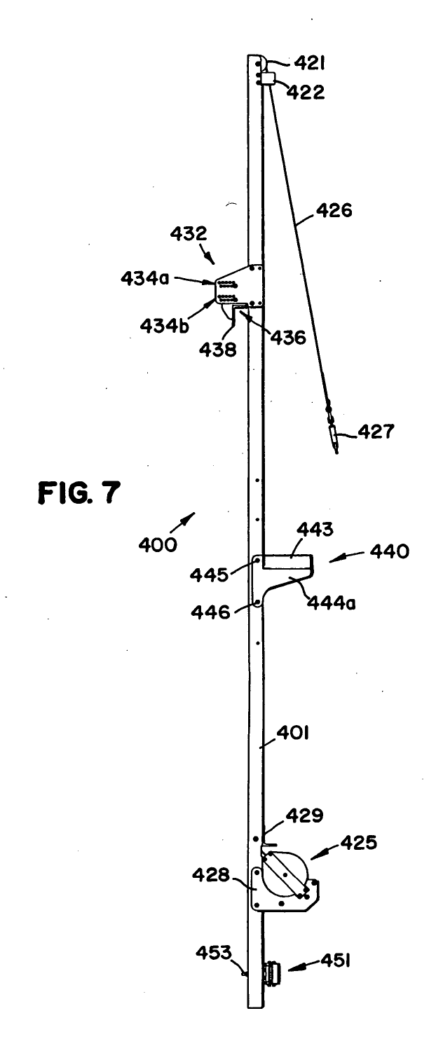

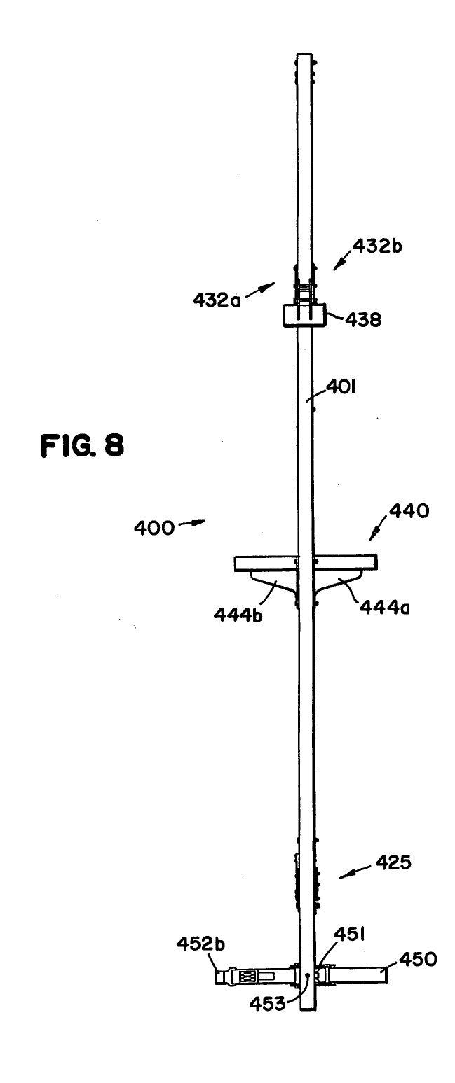

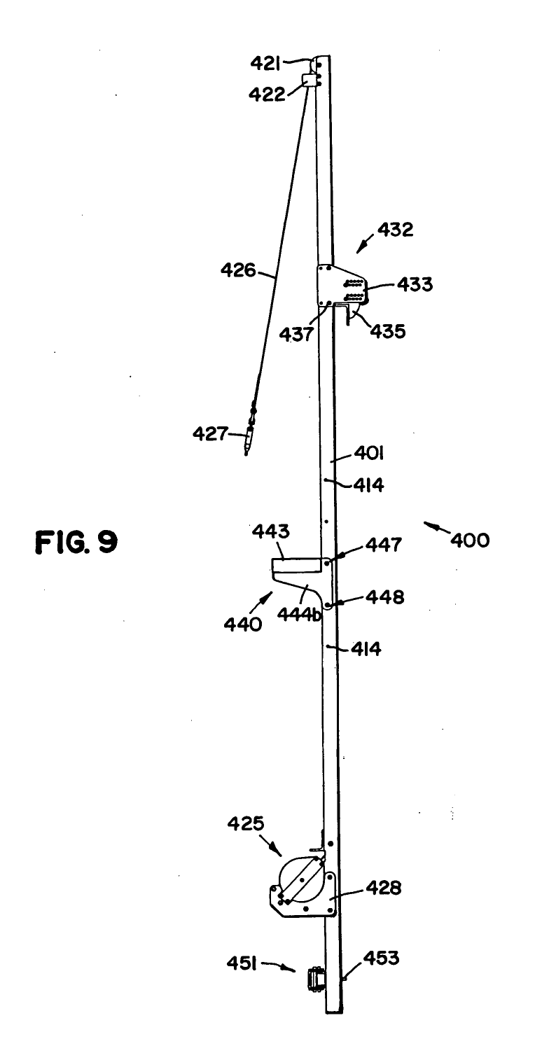

The preferred embodiment safety device 400, shown in FIGS. 6-9, includes an elongate member 401, a lifeline 425, a connecting member 432, and a support member 440. The elongate member 401 includes a first end 405, a second end 406, and an intermediate portion 407. The elongate member 401 is preferably a hollow tubular member. A pulley device 421 is operatively connected to the first end 405 proximate the top of the first end 405, and a guide 422 is operatively connected to a front side of the first end 405 proximate the bottom of the pulley device 421. The guide 422 is preferably a U-shaped bracket operatively connected at each end to the first end 405 with a space between the portion interconnecting the two ends of the guide 422 and the first end 405. The elongate member 401 also includes a slot 410 proximate the second end 406. The intermediate portion 407 includes a plurality of bores 414 aligned vertically therein.

A lifeline 425 is operatively connected to the elongate member 401 proximate the front side of the second end 406 with a bracket 428. The bracket 428 is mounted to the elongate member 401 below the slot 410, and the lifeline 425 is mounted on the top of the bracket 428. The lifeline 425 is preferably a self-retracting lifeline including webbing 426 with a hook 427 at the end. The webbing 426 is inserted through the slot 410, into the hollow center of the elongate member 401, and upward to the top of the first end 405. The webbing 426 is then placed around a portion of the pulley device 421 and downward, with the guide 422 guiding the webbing 426 downward and protecting the webbing 426. In addition, a shield 429 may be mounted above the slot 410 to protect the webbing 426. The shield is preferably L-shaped with one end extending outward proximate the top of the slot 410 to protect the webbing 426.

A connecting member 432 includes a first plate 432a and a second plate 432b, which are each preferably L-shaped with a bracket portion 433 and a hook portion 435, the bracket portion 433 extending outward from the elongate member 401 and the hook portion 435 extending downward from the bracket portion 433. The first plate 432a and the second plate 432b are spaced apart to accommodate the diameter of the elongate member 401 and are interconnected with a connecting portion 438. The bracket portions 433 each include first apertures 434a and second apertures 434b, which are configured and arranged to align with bores in an upper portion of the intermediate portion 407. Fasteners 437 are inserted through the apertures and the bores to secure the connecting member 432 to the elongate member 401, and the apertures allow the connecting member 432 to be horizontally adjusted along the length of the bracket portion 433. The hook portions 435 extend outward from the first elongate member 401 on the rear side of the device and form an opening 436 between the hook portions 435 and the elongate member 401. Preferably, the connecting portion 438 is operatively connected to the hook portions 435 proximate the opening 436 to also act as a guide when hooking the connecting member 432 to a structure. The connecting portion 438 provides an even surface to prevent hooking just one of the hook portions 435 on the structure.

A support member 440 includes a ledge 443 and ledge supports 444a and 444b. The ledge 443 interconnects the tops of the ledge supports 444a and 444b, which are spaced apart to accommodate the diameter of the elongate member 401 and to provide support for the ledge 443. The ledge supports 444a and 444b each include apertures 447 and 448, which correspond with adjacent bores 414 and through which fasteners 445 and 446 are inserted to operatively connect the support member 440 to the elongate member 401. The support member 440 is adjustable along the length of the elongate member 401. The ledge 443 is operatively connected to and extends outward from the front side of the elongate member 401 via the ledge supports 444a and 444b. The ledge 443 provides a surface upon which a user may stand to support the user while performing tasks proximate the structure.

A securing member 450 and a ratcheting device 451 are operatively connected to the front side of the second end 406 with a fastener 453. The securing member 450 is preferably a strap made of webbing with a female buckle portion 452a on one end and a male buckle portion 452b on the other end. After the securing member 450 has been buckled around a portion of the structure, the ratcheting device 451 is used to tighten the securing member 450.

In operation, the safety device 100, 300, or 400 hooks onto the top of a wall portion of the upright structure and is then secured around a portion of the anchor member with a strap. A load binder may be used to secure the strap tightly around the anchor member. Load binders are well known in the art and examples of suitable load binders that may be used are disclosed in U.S. Pat. Nos. 5,282,296 and 5,560,086, which are incorporated herein by reference, and securing the straps to the respective load binders is also well known in the art.

The lifeline, such as a self-retracting lifeline, is anchored to the form via the safety device. Preferably, 18 feet of cable, webbing, rope, or other suitable lifelines should be used with the self-retracting lifeline. A person may connect to the lifeline and then climb the form or the device to the top of the form. Should the person fall as he/she is climbing to the top of the form, or even climbing down from the top of the form, the lifeline will protect against injury because the lifeline is anchored from the ground without having to climb on the form. The device includes a support member, which provides a surface upon which the person may stand more stably.

Although the lifeline is shown operatively connected to the bottom and to the top of the device, it is recognized that the lifeline may be operatively connected to the device at any location. As shown in FIGS. 1 and 6-9, the lifeline is operatively connected proximate the bottom of the device, and the lifeline runs up through the hollow center of the elongate member of the device to the top of the device. As shown in FIG. 2, the lifeline is operatively connected proximate the top of the device. The lifeline may also be operatively connected to the device along the intermediate portion. A hook at the end of the lifeline may be releasably secured proximate the bottom of the device for easy retrieval by the user once the device has been secured to the form.

The preferred embodiments show the elongate member as a tubular post, but it is recognized that the elongate member may be a ladder or any other suitable elongate member known in the art. In addition, the support member is adjustable along the length of the device to accommodate varying heights of people or of structures, and the support member may also be foldable or collapsible for easier use and storage. The connecting portion of the device is also adjustable to accommodate varying widths of structure walls.

The above specification, examples and data provide a complete description of the manufacture and use of the composition of the invention. Since many embodiments of the invention can be made without departing from the spirit and scope of the invention, the invention resides in the claims hereinafter appended.

1. A safety device for use with an upright structure and an anchor member, comprising:
a) an elongate member having a first end, a second end, and an intermediate portion;
b) a connecting member operatively connected to said elongate member proximate said first end, said connecting member extending outward from said elongate member and being configured and arranged to engage the upright structure;
c) a securing member operatively connected to said elongate member proximate said second end, said securing member being configured and arranged to extend around a portion of the anchor member, said connecting member and said securing member anchoring said elongate member thereby providing an anchorage point; and
d) a lifeline operatively connected to said elongate member, wherein said lifeline provides fall protection proximate the upright structure when said elongate member is anchored.

2. The safety device of claim 1, wherein said elongate member is a post.

3. The safety device of claim 1, wherein said connecting member is a hook.

4. The safety device of claim 1, wherein said securing member is a strap.

5. The safety device of claim 1, wherein said lifeline is a self-retracting lifeline.

6. The safety device of claim 1, further comprising a support member operatively connected to said intermediate portion of said elongate member, said support member being adjustable along said elongate member.

7. The safety device of claim 6, wherein said support member is a footrest.

8. A safety device for use with a concrete column form, the concrete column form including a top and a base, the top having an opening providing access into a cavity, comprising:
a) an elongate member having a first end, a second end, and an intermediate portion;
b) a connecting member operatively connected to said elongate member proximate said first end, said connecting member extending outward from said elongate member and is configured and arranged to be positioned through the opening and into the cavity of the concrete column form thereby engaging the top of the concrete column form;
c) a securing member operatively connected to said elongate member proximate said second end, said securing member being configured and arranged to extend around a portion of the base of the concrete column form, said connecting member and said securing member anchoring said elongate member to the concrete column form thereby providing an anchorage point; and
d) a lifeline operatively connected to said elongate member, wherein said lifeline provides fall protection for a user proximate the concrete column form when said elongate member is anchored to the concrete column form.

9. The safety device of claim 8, further comprising a support member operatively connected to said intermediate portion of said elongate member, said support member being adjustable along said elongate member.

10. The safety device of claim 9, wherein said support member is a footrest.

11. The safety device of claim 8, wherein said elongate member is a post.

12. The safety device of claim 8, wherein said connecting member extends downward from said elongate member.

13. The safety device of claim 12, wherein said connecting member is a hook.

14. The safety device of claim 8, wherein said securing member is a strap.

15. The safety device of claim 8, wherein said lifeline is a self-retracting lifeline.

16. A safety device for use with an upright structure including a top and an anchor member, comprising:
a) a post having a first end, a second end, and an intermediate portion;
b) a hook operatively connected to said post proximate said first end, said hook extending outward from said post and being configured and arranged to engage the top of the upright structure;
c) a strap operatively connected to said post proximate said second end, said strap being configured and arranged to extend around a portion of the anchor member, said hook and said strap anchoring said post thereby providing an anchorage point; and
d) a lifeline operatively connected to said post, wherein said lifeline provides fall protection proximate the upright structure when said post is anchored.

17. The safety device of claim 16, further comprising a support member operatively connected to said intermediate portion of said post, said support member being adjustable along said post.

18. The safety device of claim 16, wherein said lifeline is a self-retracting lifeline.

19. The safety device of claim 16, wherein said strap is secured with a ratcheting device.

20. A method of securing a safety device including a lifeline to a concrete column form, the concrete column form including a top and a base, the top having an opening providing access into a cavity, the safety device being secured from a level below the top of the concrete column form, comprising:
a) placing a connecting member through the opening into the cavity of the concrete column form, the connecting member being operatively connected to a first end of an elongate member, the connecting member connecting the first end of the elongate member to the top of the concrete column form; and
b) securing a strap operatively connected to the elongate member proximate a second end of the elongate member around a portion of the base of the concrete column form.

21. The method of claim 20, further comprising adjusting a support member slidably operatively connected to the elongate member along the elongate member.

22. The method of claim 20, further comprising tightening the strap around the portion of the base of the concrete column form with a ratcheting device.

23. A method of securing a safety device including a lifeline to an upright structure including a top, the safety device being secured from a level below the top of the upright structure, comprising:
a) standing at the level below the top of the upright structure;
b) placing a connecting member over the top of the upright structure thereby engaging the top of the upright structure with the connecting member, the connecting member being operatively connected to a first end of an elongate member, the connecting member connecting the first end of the elongate member to the top of the upright member;
c) securing a strap operatively connected to the elongate member proximate a second end of the elongate member around a portion of an anchor member; and
d) tightening the strap around the portion of the anchor member with a ratcheting device.

24. The method of claim 23, further comprising adjusting a support member slidably operatively connected to the elongate member along the elongate member.
